(19) United States
(12) Patent Application Publication
(10) Pub. No.: US 2026/0213355 A1
(43) Pub. Date: Jul. 23, 2026

(54) BATTERY ASSEMBLY

(71) Applicant: SK ON CO., LTD., Seoul (KR)

(72) Inventor: Ji Eun KANG, Daejeon (KR)

(21) Appl. No.: 19/439,478

(22) Filed: Jan. 5, 2026

(30) Foreign Application Priority Data
Jan. 17, 2025 (KR) 10-2025-0007324

(51) Int. Cl. H01M 50/503; H01M 10/48; H01M 50/211

(52) U.S. Cl. CPC H01M 50/503; H01M 10/482; H01M 50/211

(57) ABSTRACT

The present disclosure relates to a battery assembly comprising: a plurality of battery cells arranged along a stacking direction; a receiving case that receives the plurality of battery cells; a busbar located at a side surface of the plurality of battery cells inside the receiving case and disposed along the stacking direction; a busbar terminal portion protruding from the busbar inside the receiving case and bent to surround at least a portion of the plurality of battery cells; and a circuit portion disposed on the same plane as one bent end of the busbar terminal portion and electrically connected to the busbar terminal portion.

### CROSS-REFERENCE TO RELATED PATENT APPLICATION

The present application claims priority under 35 U.S.C. § 119(a) to Korean patent application number 10-2025-0007324 filed on Jan. 17, 2025, in the Korean Intellectual Property Office, the entire disclosure of which is incorporated by reference herein.

### BACKGROUND OF THE INVENTION

### 1. Field

The present disclosure relates to a battery assembly.

### 2. Description of the Related Art

A secondary battery is a battery that stores electrical energy by converting it into chemical energy, and enables reuse over multiple cycles through charging and discharging. Due to its economic and eco-friendly characteristics, the secondary battery is used widely across various industries. In particular, among secondary batteries, a lithium secondary battery is extensively utilized in industries, including portable devices that require high-density energy.

Meanwhile, in order to increase the capacity and output of the secondary battery, a plurality of secondary batteries may be bundled together. A busbar may be used to electrically connect each of the secondary batteries. The battery assembly may be provided with a sensing circuit that acquires information related to the secondary battery through the busbar connected to the secondary battery. At this time, there may be a risk that terminals connecting the sensing circuit and the busbar are vulnerable to damage, and a structure and shape of the sensing circuit and the busbar to prevent this may be required. Accordingly, research on the structure and shape of the sensing circuit and the busbar is being actively conducted.

### SUMMARY OF THE INVENTION

According to one aspect of the present disclosure, a problem to be solved is to improve the physical or electrical stability of a battery assembly.

According to another aspect of the present disclosure, a problem to be solved is to improve the lifespan of the battery assembly.

According to still another aspect of the present disclosure, a problem to be solved is to reduce the manufacturing cost of the manufacturing process of the battery assembly.

Meanwhile, the present disclosure can be widely applied in fields of green technology such as electric vehicles, battery charging stations, energy storage systems (ESS), photovoltaics, and wind power using batteries. In addition, the present disclosure can be used in eco-friendly mobility including electric vehicles and hybrid vehicles for preventing climate change by suppressing air pollution and greenhouse gas emissions.

As a technical means to achieve the technical objects, a battery assembly according to the present disclosure comprises: a plurality of battery cells arranged along a stacking direction; a receiving case that receives the plurality of battery cells; a busbar located at a side surface of the plurality of battery cells inside the receiving case and disposed along the stacking direction; a busbar terminal portion protruding from the busbar inside the receiving case and bent to surround at least a portion of the plurality of battery cells; and a circuit portion disposed on the same plane as one bent end of the busbar terminal portion and electrically connected to the busbar terminal portion.

In addition, the one bent end of the busbar terminal portion may be disposed between the receiving case and the plurality of battery cells with respect to a height direction of the receiving case.

In addition, the circuit portion may include a sensing terminal portion that contacts the one bent end of the busbar terminal portion.

In addition, the sensing terminal portion may include one end disposed on the circuit portion and the other end extending from the one end toward the bent busbar terminal portion.

In addition, the other end of the sensing terminal portion may be disposed on the one bent end of the busbar terminal portion.

In addition, the busbar may include one or more busbar plates each comprising the busbar terminal portion.

In addition, the one or more busbar plates may be arranged along the stacking direction.

In addition, a busbar frame having at least a portion that is plate-shaped and disposed at the side surface of the plurality of battery cells and extending along the stacking direction may be further included, and the busbar may be supported by the busbar frame.

In addition, a circuit portion frame that surrounds at least a portion of the plurality of battery cells and is connected to the busbar frame may be further included, and the busbar frame may include a support portion on which the circuit portion frame is disposed and which covers a part of an upper surface of the plurality of battery cells.

In addition, the circuit portion may include a substrate portion disposed on the circuit portion frame.

In addition, a first coupling portion may be included to maintain a coupled state between at least a part of the circuit portion frame and the substrate portion.

In addition, a second coupling portion may be included to fix at least a part of the busbar frame and the circuit portion.

In addition, the second coupling portion may be formed by fusion-bonding a first sub-coupling portion disposed on the busbar frame and a second sub-coupling portion disposed on the circuit portion frame to each other.

In addition, the busbar terminal portion may be electrically connected to at least one of the plurality of battery cells.

In addition, the circuit portion may receive information of the plurality of battery cells via the busbar terminal portion.

### BRIEF DESCRIPTION OF THE DRAWINGS

FIG. 1 is a diagram showing a battery assembly according to an embodiment of the present disclosure.

FIG. 2 is a diagram showing a battery cell according to an embodiment of the present disclosure.

FIG. 3 is a diagram showing an embodiment before a busbar and a busbar frame according to the present disclosure are coupled to a circuit portion frame.

FIG. 4 is a diagram showing an embodiment after the busbar and the busbar frame according to the present disclosure are coupled to the circuit portion frame.

FIG. 5 is a diagram specifically showing a first region of FIG. 4.

FIG. 6 is a schematic cross-sectional view of a busbar assembly along A-A′ of FIG. 4.

### DETAILED DESCRIPTION

Hereinafter, preferred embodiments of the present disclosure will be described in detail with reference to the accompanying drawings. The configuration of the device or the control method described below is merely for explaining the embodiments of the present disclosure and not intended to limit the scope of the present disclosure, and reference numerals used consistently throughout the specification denote the same components.

The use of terms such as “first, second, third,” and the like in reference to components mentioned below is merely to avoid confusion between the components, and is not related to order, importance, or hierarchy among the components. For example, an invention including only a second component without a first component may also be implemented.

In order to describe the present disclosure, a spatial orthogonal coordinate system defined by mutually orthogonal X-axis, Y-axis, and Z-axis will be used as a reference hereinafter. Each axis direction (X-axis direction, Y-axis direction, Z-axis direction) means both extending directions of each axis.

In the present disclosure, the X direction may be a protrusion direction of a cell tab 120, the Y direction may be a stacking direction of battery cells 100, and the Z direction may be a height direction of a receiving case 200. However, the X direction, Y direction, and Z direction mentioned below are merely for describing the present disclosure so that it can be clearly understood, and of course, each direction may be defined differently depending on where the reference is set.

In the present disclosure, singular expressions include plural expressions unless the context clearly indicates otherwise.

Meanwhile, in the present disclosure, the terms battery, secondary battery, or cell are used to have the same meaning as a battery cell.

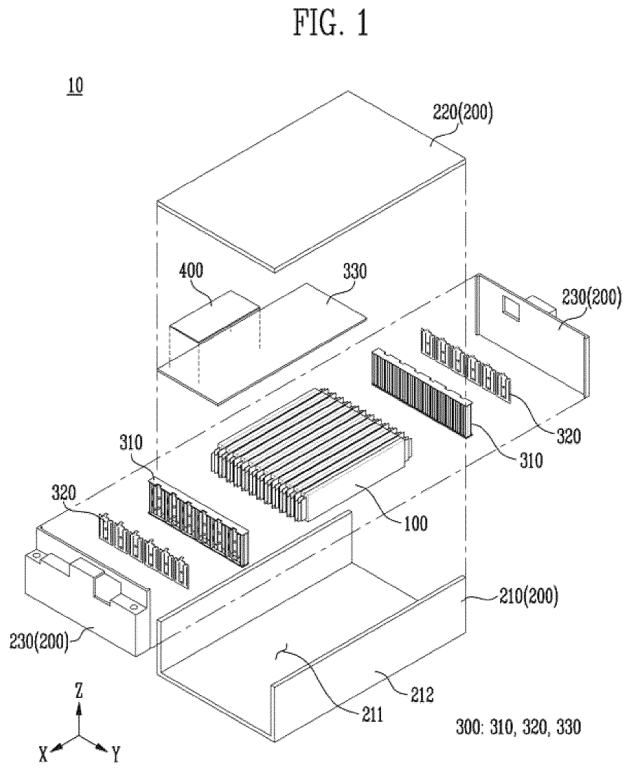

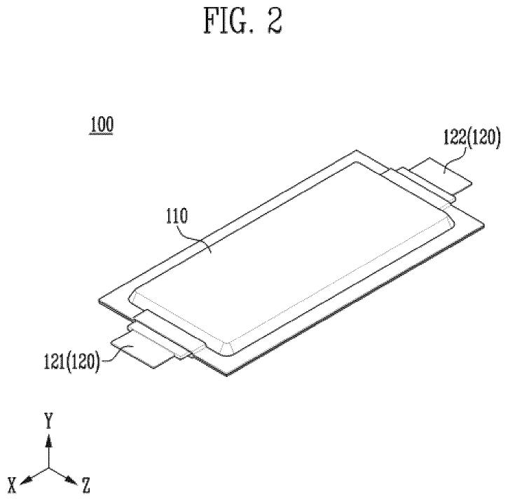

FIG. 1 is a diagram showing a battery assembly according to an embodiment of the present disclosure. FIG. 2 is a diagram showing a battery cell according to an embodiment of the present disclosure.

Referring to FIG. 1, a battery assembly 10 of the present disclosure includes a plurality of battery cells 100. The battery cell 100 described in this specification refers to a secondary battery that can be repeatedly used by charging and discharging electrical energy. For example, it may refer to a lithium secondary battery or a lithium ion battery, but is not limited thereto. In another example, it may refer to an all-solid-state battery.

The battery cell 100 may be classified into a pouch-type secondary battery, a prismatic secondary battery, or a cylindrical secondary battery according to its shape. Referring to FIG. 2, for convenience of explanation, a pouch-type secondary battery is illustrated as an example in this specification, but the present disclosure is not limited thereto.

Meanwhile, the battery assembly 10 described in this specification refers to a battery module in which one or more battery cells 100 are grouped and placed in a case to protect them from external impact, heat, and vibration, and to provide high output and high capacity characteristics.

The battery cell 100 may include a positive electrode and a negative electrode. The positive electrode may include a positive electrode active material into which lithium ions can be inserted and from which lithium ions can be desorbed. The negative electrode may include a negative electrode active material into which lithium ions can be inserted and from which lithium ions can be desorbed. The battery cell 100 may further include a separator that prevents an electrical short circuit between the positive electrode and the negative electrode and allows the flow of ions.

In one embodiment, the positive electrode, the negative electrode, and the separator may be stacked to form an electrode assembly. The electrode assembly may be classified into a stacking type, a winding type, a stack-folding type, or a Z-stacking type according to the manner in which the positive electrode, the negative electrode, and the separator are stacked. The battery cell 100 of the present disclosure may include an electrode assembly stacked in various ways without being limited to any one stacking method. In other words, the battery cell 100 of the present disclosure may store and supply electrical energy by including an electrode assembly stacked by various methods.

Referring to FIG. 2, the battery cell 100 may further include an exterior material 110 that accommodates the electrode assembly therein. The electrode assembly and an electrolyte may be accommodated inside the exterior material 110. The exterior material 110 may include an outer insulating layer of a polymer material, an inner adhesive layer, and a metal layer interposed between the outer insulating layer and the inner adhesive layer. The exterior material 110 may include a material having high mechanical rigidity to protect the battery cell 100 from external impact. For example, the case may include an aluminum layer.

The battery cell 100 may further include a cell tab 120 protruding to the outside of the exterior material 110 for electrical connection with the outside. The cell tab 120 may be respectively connected to the positive electrode and the negative electrode of the battery cell 100. The cell tab 120 may include a positive electrode tab 121 connected to the positive electrode and a negative electrode tab 122 connected to the negative electrode.

The plurality of battery cells 100 may be stacked in one direction. Referring to FIG. 1, the plurality of battery cells 100 may be sequentially stacked along the Y direction. Through this, energy density can be improved by a structure that minimizes waste of space.

The battery assembly 10 of the present disclosure includes a receiving case 200 that accommodates the plurality of battery cells 100. The receiving case 200 may accommodate the battery cells 100 therein. The receiving case 200 may prevent damage to the battery cells 100 from external impact, heat, vibration, or pressure.

The receiving case 200 may include a support body 210 that supports the plurality of battery cells 100 and a cover body 220 that is coupled to the support body 210 and covers the plurality of battery cells 100. In one embodiment, the support body 210 and the cover body 220 may be connected to form a hexahedral shape with the front and rear surfaces open. Through this, the energy density of the battery assembly 10 can be maximized.

Referring to FIG. 1, the support body 210 may include an opening 211 open toward the upper surface. In one embodiment, the support body 210 may include an opening 211 open toward the Y direction. Through the opening 211, the plurality of battery cells 100 may be positioned on the support body 210. The support body 210 may include a side body formed by edges extending toward the upper surface to cover the plurality of battery cells 100. In one embodiment, the support body 210 may be formed in a “U” shape.

The cover body 220 may be coupled to the support body 210. The cover body 220 may be coupled to the support body 210 to form an inner surface of an inner space of the receiving case 200. The receiving case 200 may further include an end cover 230. The end cover 230 may be connected to the support body 210 and the cover body 220 to form one side surface of the inner space of the receiving case 200. Ultimately, the receiving case 200 may be formed in a hexahedral shape by the support body 210, the cover body 220, and the end cover 230 to protect the battery cells 100.

The battery assembly 10 of the present disclosure may include a busbar assembly 300. The busbar assembly 300 may electrically connect at least a portion of the plurality of battery cells 100.

The busbar assembly 300 may include a busbar frame 310, a busbar 320, and a busbar circuit portion frame 330.

The busbar frame 310 may cover the plurality of battery cells 100 in the protrusion direction of the cell tab 120. Referring to FIG. 1, the busbar frame 310 may be located outside the plurality of battery cells 100 along the X direction. In addition, the busbar frame 310 may extend along the direction in which the plurality of battery cells 100 are stacked. Through this, the busbar frame 310 may easily and efficiently contact at least a portion of the plurality of battery cells 100.

The busbar 320 may be connected to the busbar frame 310. The busbar frame 310 may be positioned between the busbar 320 and the plurality of battery cells 100. Through this, the plurality of battery cells 100 can be protected.

In addition, each cell tab 120 included in the plurality of battery cells 100 may be inserted into the busbar frame 310. For this purpose, a region of the busbar frame 310 may be formed to be penetrated so that the cell tab 120 is inserted. For example, the busbar frame 310 may include a through-hole or a slit.

According to an embodiment, the busbar frame 310 may be disposed at a side surface of the battery cell 100 and may have at least a portion that is plate shaped extending along the stacking direction of the battery cell 100. However, this is merely exemplary, and the structure of the busbar frame 310 is not particularly limited, and a known configuration may be applied.

The busbar 320 may be supported by the busbar frame 310. For example, the busbar 320 may be connected (or coupled) to the busbar frame 310 on one surface of the busbar frame 310 that does not face the plurality of battery cells 100. However, this is merely exemplary, and the busbar 320 may be formed as a single member.

The busbar 320 may be located at a side surface of the plurality of battery cells 100 (see FIG. 1) inside the receiving case 200 and may be disposed along the stacking direction of the plurality of battery cells 100.

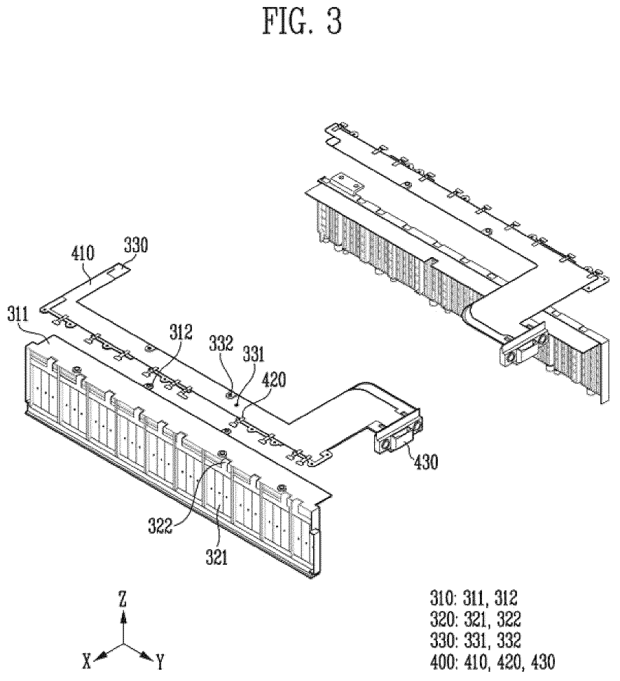

The busbar 320 may be formed in a plurality. The plurality of busbars 320 may be arranged along the stacking direction of the battery cells 100. For example, the busbar 320 may include one or more busbar plates 321 (see FIG. 3). In this case, the one or more busbar plates 321 may be arranged along the stacking direction of the battery cells 100.

The cell tab 120 may be inserted into the through-hole of the busbar frame 310 so that a portion thereof protrudes to the outside. The protruding cell tab 120 may be electrically connected to the busbar 320 (or the busbar plate 321).

The battery assembly 10 of the present disclosure may further include a circuit portion frame 330 and a circuit portion 400.

The circuit portion frame 330 may surround at least a portion of the plurality of battery cells 100 and may be connected to the busbar frame 310. The circuit portion frame 330 may extend along the protrusion direction of the cell tab 120. For example, the circuit portion frame 330 may extend along the X direction. The circuit portion frame 330 may be connected to the busbar frame 310 and the busbar 320 located on both sides of the plurality of battery cells 100.

According to an embodiment, the busbar frame 310, the busbar 320, and the circuit portion frame 330 may be assembled to form the busbar assembly 300. For example, after the busbar frame 310 and the busbar 320 are assembled, the integrally configured busbar frame 310 and busbar 320 may be combined with the circuit portion frame 330 to form the busbar assembly 300.

The circuit portion 400 may be disposed on the circuit portion frame 330. For example, the circuit portion frame 330 may be disposed between the circuit portion 400 and the battery cells 100.

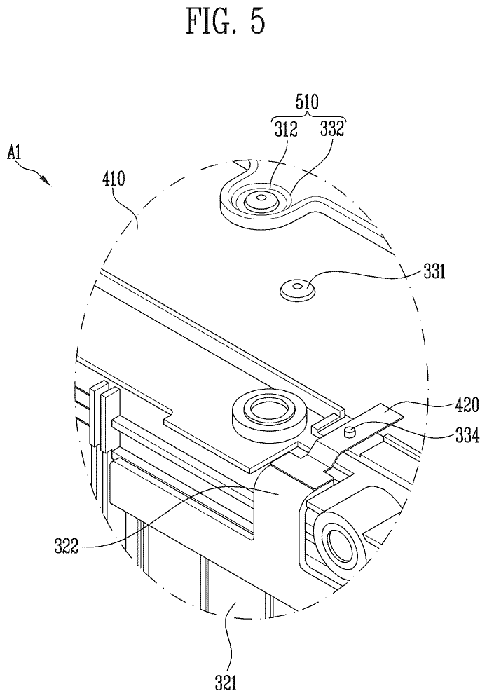

In an embodiment, the circuit portion 400 may be electrically connected to the busbar assembly 300 to acquire information of at least one of the plurality of battery cells 100. For example, the circuit portion 400 may receive information of the plurality of battery cells 100 via the busbar 320 or the busbar terminal portion 322 (see FIG. 5).

The information of the battery cell 100 may be information for controlling and managing the battery cell 100. For example, the information of the battery cell 100 may be information on voltage, current, remaining capacity, temperature, and humidity of the battery cell 100. In addition, the information of the battery cell 100 may be charging information (State of Charge) of the battery cell 100. However, this is merely exemplary, and the information of the battery cell 100 is not limited thereto.

According to an embodiment, the circuit portion 400 may include a battery cell management system. In other words, the circuit portion 400 may include a battery cell management system that communicates with the outside and efficiently controls the plurality of battery cells 100. According to an embodiment, the battery cell management system may be implemented by wireless communication, but is not limited thereto.

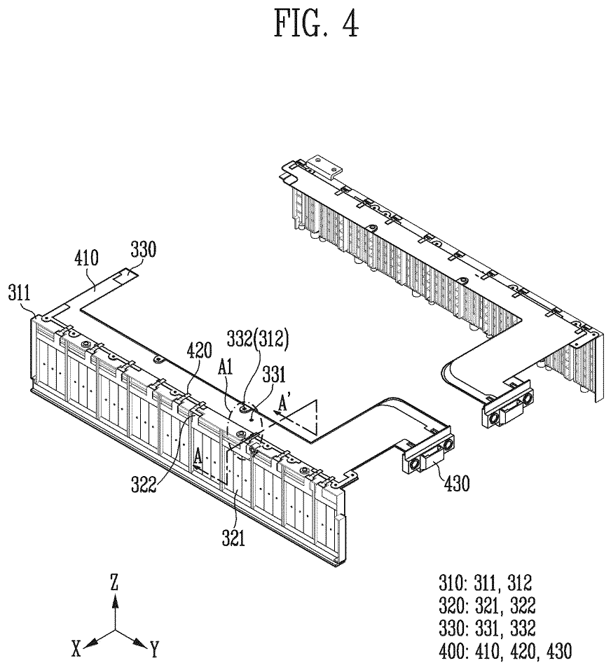

FIG. 3 is a diagram showing an embodiment before a busbar and a busbar frame according to the present disclosure are coupled to a circuit portion frame. FIG. 4 is a diagram showing an embodiment after the busbar and the busbar frame according to the present disclosure are coupled to the circuit portion frame. FIG. 5 is a diagram specifically showing a first region of FIG. 4.

Referring to FIG. 3, the busbar frame 310 may include a support portion 311 and a first sub-coupling portion 312. The busbar 320 may include a busbar plate 321 and a busbar terminal portion 322. The circuit portion frame 330 may include a first coupling portion 331 and a second sub-coupling portion 332.

The busbar frame 310 may include the support portion 311 that covers a part of the upper surface of the plurality of battery cells 100 (see FIG. 1). For example, the busbar frame 310 may have an inverted L-shape in the Y direction. In this case, the support portion 311 may be a configuration of the busbar frame 310 in the X direction.

The support portion 311 may be the upper surface of the busbar frame 310 on which the circuit portion frame 330 is seated. Accordingly, the support portion 311 may contact at least a portion of the circuit portion frame 330. For example, the support portion 311 may contact the rear surface of the circuit portion frame 330.

The first sub-coupling portion 312 may be provided to maintain a coupled state of at least a portion of the busbar frame 310 and the circuit portion 400. In addition, the second sub-coupling portion 332 may be provided to maintain a coupled state of at least a portion of the busbar frame 310 and the circuit portion 400. Referring to FIGS. 3 and 4, the first sub-coupling portion 312 disposed on the busbar frame 310 and the second sub-coupling portion 332 disposed on the circuit portion frame 330 may contact each other and be fusion-bonded. Accordingly, a second coupling portion 510 that fixes at least a portion of the busbar frame 310 and the circuit portion 400 may be formed. In other words, in the process of coupling the busbar frame 310 and the circuit portion frame 330 to each other, the first sub-coupling portion 312 and the second sub-coupling portion 332 may be fusion-bonded to each other and transformed into one configuration. Accordingly, the second coupling portion 510 formed in this manner may maintain the busbar frame 310, the circuit portion frame 330, and the circuit portion 400 in a stably coupled state. According to an embodiment, heat may be applied to the first sub-coupling portion 312 and the second sub-coupling portion 332 to be fusion-bonded, but the fusion bonding method is not limited thereto.

The busbar 320 may include one or more busbar plates 321 each including a busbar terminal portion 322. For example, the busbar plate 321 may be configured in a plurality, and each may include a busbar terminal portion 322. However, the present disclosure is not limited thereto. According to an embodiment, the busbar plate 321 may be configured as a single plate and may include a plurality of busbar terminal portions 322.

The one or more busbar plates 321 may be electrically connected to the battery cells 100 (see FIG. 1). For example, the one or more busbar plates 321 may contact at least a portion of the cell tabs 120 (see FIG. 2) of the battery cells 100. Accordingly, the busbar plate 321 may be electrically connected to the battery cells 100 through the cell tabs 120.

Inside the receiving case 200, the busbar terminal portion 322 may protrude from the busbar 320 and be bent to surround at least a portion of the plurality of battery cells 100. For example, the busbar terminal portion 322 may extend in the Z direction from the busbar plate 321 to surround at least a portion of the plurality of battery cells 100.

The circuit portion frame 330 may be at least partially disposed on the support portion 311. For example, at least a part of the circuit portion frame 330 may be disposed to overlap with a part of the support portion 311 in the height direction of the receiving case 200 (see FIG. 1).

The substrate portion 410 may be disposed on the circuit portion frame 330. For example, the substrate portion 410 may be seated or mounted on at least a part of the circuit portion frame 330. Accordingly, the circuit portion frame 330 may support the substrate portion 410 in the Z direction.

Meanwhile, for convenience of explanation, in FIG. 3, at least a part of the configuration of the circuit portion frame 330 is illustrated. Therefore, the shape of the circuit portion frame 330 is not limited to that shown in FIG. 3.

Referring to FIGS. 3 to 5, the circuit portion frame 330 may include a first coupling portion 331. For example, referring to the first region A1 of FIGS. 4 and 5, the first coupling portion 331 may be one of the configurations disposed on an upper surface of the circuit portion frame 330.

The first coupling portion 331 may maintain a coupled state between at least a portion of the circuit portion frame 330 and the substrate portion 410. For example, the first coupling portion 331 may be configured to maintain a coupled state between the circuit portion frame 330 and the substrate portion 410 after the substrate portion 410 is disposed on the circuit portion frame 330. According to an embodiment, the first coupling portion 331 may be formed by fusion-bonding respective configurations of the circuit portion frame 330 and the substrate portion 410. However, the present disclosure is not limited thereto.

The circuit portion frame 330 may include a second sub-coupling portion 332 disposed thereon. As described above, the second sub-coupling portion 332 may be coupled with the first sub-coupling portion 312. Accordingly, the first sub-coupling portion 312 and the second sub-coupling portion 332 may be coupled to form the second coupling portion 510.

Referring to FIG. 5, the circuit portion frame 330 may include a fixing portion 334. The fixing portion 334 may be disposed on the circuit portion frame 330. For example, referring to the first region A1 of FIGS. 4 and 5, the fixing portion 334 may be a configuration protruding in the height direction (for example, the Z direction) of the receiving case 200 (see FIG. 1) on the circuit portion frame 330.

The fixing portion 334 may stably fix the sensing terminal portion 420. For example, the fixing portion 334 may have an opening of the sensing terminal portion 420. In this case, the opening of the sensing terminal portion 420 may be inserted into the fixing portion 334. Accordingly, the sensing terminal portion 420 may be fixed by the fixing portion 334 and may stably maintain a state of contact with the busbar terminal portion 322.

The circuit portion 400 may include a substrate portion 410, a sensing terminal portion 420, and an input/output portion 430.

The substrate portion 410 may be disposed on the circuit portion frame 330. On a plane, the substrate portion 410 may have a shape corresponding to the shape of the circuit portion frame 330. According to an embodiment, on a plane viewed in the direction opposite to the Z direction, the substrate portion 410 may have an area equal to or smaller than the area of the circuit portion frame 330. Accordingly, the substrate portion 410 may be seated on the circuit portion frame 330. However, the present disclosure is not limited thereto.

The substrate portion 410 may be electrically connected to the outside through the input/output portion 430. For example, the substrate portion 410 may acquire information related to the stacked battery cells 100 (see FIG. 1). Accordingly, the substrate portion 410 may transmit an electrical signal corresponding to the information to the outside through the input/output portion 430. In addition, the substrate portion 410 may receive a plurality of signals from the outside through the input/output portion 430. However, according to an embodiment, as described above, the circuit portion 400 may be implemented as a self-contained battery management system.

At least a portion of the sensing terminal portion 420 may be disposed on the circuit portion 400 (see FIG. 5) or the substrate portion 410. In this case, the sensing terminal portion 420 may contact at least a portion of the busbar terminal portion 322.

According to an embodiment of the present disclosure, the substrate portion 410 may be implemented as a printed circuit board (PCB). For example, the substrate portion 410 may be implemented as a printed circuit board electrically connected to the sensing terminal portion 420 and the busbar terminal portion 322. According to another embodiment, the substrate portion 410 may be implemented as a flexible printed circuit board (FPCB). However, the present disclosure is not limited thereto.

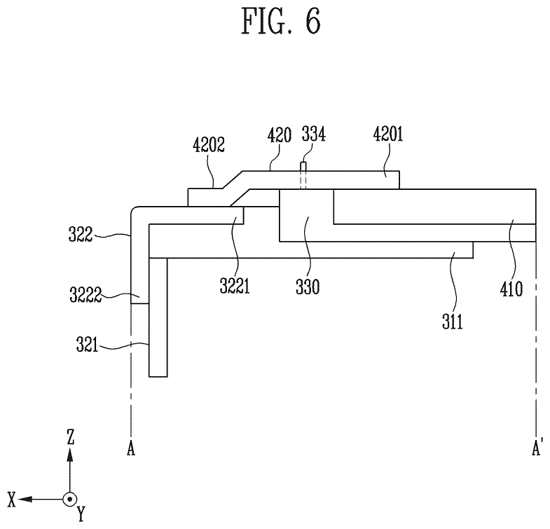

FIG. 6 is a schematic cross-sectional view of a busbar assembly along A-A′ of FIG. 4. Meanwhile, the arrangement relationship of the components shown in FIG. 6 is schematically illustrated for convenience of explanation, and is not limited thereto.

Referring to FIG. 6, the busbar terminal portion 322 may include a bent one end 3221. For example, the busbar terminal portion 322 may include the bent one end 3221 bent to surround the battery cell 100 (see FIG. 1) or the support portion 311 of the busbar frame 310.

The bent one end 3221 of the busbar terminal portion 322 may be disposed between the receiving case 200 (see FIG. 1) and the plurality of battery cells 100 with respect to the height direction of the receiving case 200. For example, referring to FIGS. 1 and 6, the one end 3221 may be disposed in the Z direction between the cover body 220 of the receiving case 200 and the plurality of battery cells 100.

The busbar terminal portion 322 may include the other end 3222 that contacts at least a portion of the busbar plate 321. Accordingly, the busbar terminal portion 322 may electrically connect the sensing terminal portion 420 and the busbar plate 321. According to an embodiment, the other end 3222 of the busbar terminal portion 322 may be a component of the busbar plate 321. That is, the other end 3222 of the busbar terminal portion 322 may be integrally implemented with the busbar plate 321.

The circuit portion 400 may include a sensing terminal portion 420 that contacts the one bent end 3221 of the busbar terminal portion 322. For example, the sensing terminal portion 420 may be disposed on the circuit portion frame 330 and the substrate portion 410 and may contact the busbar terminal portion 322.

The sensing terminal portion 420 may include one end 4201 disposed on the circuit portion 400 and the other end 4202 extending from the one end 4201 toward the bent busbar terminal portion 322. In this case, the other end 4202 of the sensing terminal portion 420 may be disposed on the one bent end 3221 of the busbar terminal portion 322. For example, the other end 4202 of the sensing terminal portion 420 may be disposed to overlap with the one end 3221 of the busbar terminal portion 322 in the Z direction.

The circuit portion 400 may be disposed on the same plane as the one bent end 3221 of the busbar terminal portion 322 and may be electrically connected to the busbar terminal portion 322. For example, the circuit portion 400 may be electrically connected to the busbar terminal portion 322 through the sensing terminal portion 420 that contacts the bent one end 3221.

The busbar terminal portion 322 and the sensing terminal portion 420 may contact each other at an upper end of the battery cell 100 (see FIG. 1). For example, the busbar terminal portion 322 may extend from the other end 3222 and be bent in a direction opposite to the X direction so that the one end 3221 is disposed on the upper end of the battery cell 100 or on the busbar frame 310. Accordingly, the sensing terminal portion 420 may extend toward the busbar terminal portion 322 without being bent, so that the one end 3221 of the busbar terminal portion 322 and the other end 4202 of the sensing terminal portion 420 may contact each other at the upper end of the battery cell 100 in the Z direction.

According to a comparative example, if the busbar terminal portion 322 is not bent, the one end 3221 of the busbar terminal portion 322 may be disposed on a side surface (a surface in the X direction) of the battery cell 100 or the busbar frame 310. Accordingly, the sensing terminal portion 420 must be bent in a direction opposite to the Z direction in order to contact the busbar terminal portion 322, and in such a case, a separate process for bending the sensing terminal portion 420 may be required. In addition, since the sensing terminal portion 420, which is a component of the circuit portion 400, is bent, at least a part of the circuit portion 400 may be damaged, and the lifespan of the battery assembly 10 may be relatively shortened.

According to an embodiment of the present disclosure, the busbar assembly 300 (see FIG. 1) may be configured such that the busbar terminal portion 322 is bent and the one end 3221 of the busbar terminal portion 322 is disposed on the busbar frame 310. Accordingly, a separate bending process for the busbar terminal portion 322 may not be required, and the speed of the manufacturing process and the cost consumed in the manufacturing process may be relatively improved. For example, the process of manufacturing the battery assembly 10 may be carried out as an automated process. In addition, since a component of the circuit portion 400 is not bent but the busbar terminal portion 322 is bent, relatively less damage may occur to the circuit portion 400 (or the sensing terminal portion 420). Accordingly, the physical or electrical stability of the battery assembly 10 according to the present disclosure may be improved, and the lifespan of the battery assembly 10 may be relatively enhanced.

In addition, according to a comparative example, when the sensing terminal portion 420 is bent and contacts the busbar terminal portion 322 at a side surface of the battery cell 100 or a side surface of the busbar frame 310, the length of the battery assembly in the horizontal direction (for example, the X direction) according to the comparative example may become unnecessarily long.

According to an embodiment of the present disclosure, the one end 3221 of the busbar terminal portion 322 and the sensing terminal portion 420 may be disposed on the busbar frame 310, so that the horizontal length and volume of the battery assembly 10 (see FIG. 1) according to the present disclosure may be relatively reduced.

The present disclosure may be embodied in various forms, and the scope of rights is not limited to the above-described embodiments. Therefore, if a modified embodiment includes the components of the claims of the present disclosure, it shall be construed as falling within the scope of the present disclosure.

What is claimed is:

1. A battery assembly comprising:
a plurality of battery cells arranged along a stacking direction;
a receiving case that receives the plurality of battery cells;
a busbar located at a side surface of the plurality of battery cells inside the receiving case and disposed along the stacking direction;
a busbar terminal portion protruding from the busbar inside the receiving case and being bent to surround at least a portion of the plurality of battery cells; and
a circuit portion disposed coplanar with the bent one end of the busbar terminal portion and electrically connected to the busbar terminal portion.

2. The battery assembly according to claim 1, wherein the bent one end of the busbar terminal portion is disposed between the receiving case and the plurality of battery cells with respect to a height direction of the receiving case.

3. The battery assembly according to claim 2, wherein the circuit portion includes a sensing terminal portion that contacts the one bent end of the busbar terminal portion.

4. The battery assembly according to claim 3, wherein the sensing terminal portion includes one end disposed on the circuit portion and the other end extending from the one end toward the bent busbar terminal portion.

5. The battery assembly according to claim 4, wherein the other end of the sensing terminal portion is disposed on the one bent end of the busbar terminal portion.

6. The battery assembly according to claim 1, wherein the busbar includes one or more busbar plates each comprising the busbar terminal portion.

7. The battery assembly according to claim 6, wherein the one or more busbar plates are arranged along the stacking direction.

8. The battery assembly according to claim 1, further comprising a busbar frame having at least a portion that is plate-shaped and disposed at the side surface of the plurality of battery cells and extending along the stacking direction,
wherein the busbar is supported by the busbar frame.

9. The battery assembly according to claim 8, further comprising a circuit portion frame that surrounds at least a portion of the plurality of battery cells and is connected to the busbar frame,
wherein the busbar frame includes a support portion on which the circuit portion frame is disposed and which covers a part of an upper surface of the plurality of battery cells.

10. The battery assembly according to claim 9, wherein the circuit portion includes a substrate portion disposed on the circuit portion frame.

11. The battery assembly according to claim 10, further comprising a first coupling portion that maintains a coupled state between at least a part of the circuit portion frame and the substrate portion.

12. The battery assembly according to claim 9, further comprising a second coupling portion that fixes at least a part of the busbar frame and the circuit portion.

13. The battery assembly according to claim 12, wherein the second coupling portion is formed by fusion-bonding a first sub-coupling portion disposed on the busbar frame and a second sub-coupling portion disposed on the circuit portion frame to each other.

14. The battery assembly according to claim 1, wherein the busbar terminal portion is electrically connected to at least one of the plurality of battery cells.

15. The battery assembly according to claim 14, wherein the circuit portion receives information of the plurality of battery cells via the busbar terminal portion.
